(19) United States
(12) Patent Application Publication
(10) Pub. No.: US 2007/0236602 A1
(43) Pub. Date: Oct. 11, 2007

(54) Advanced pulldown format for encoding video

(76) Inventor: Michael Phillips, Melrose, MA (US)

Correspondence Address: PETER J. GORDON, PATENT COUNSEL, AVID TECHNOLOGY, INC., ONE PARK WEST, TEWKSBURY, MA, 01876, US

(21) Appl. No.: 11/732,502

(22) Filed: Apr. 3, 2007

Related U.S. Application Data
(60) Provisional application No. 60/789,053, filed on Apr. 4, 2006.

(51) Int. Cl. H04N 7/01

(52) U.S. Cl. 348/441

(57) ABSTRACT

A pulldown format for PAL that is useful for material that will be provided to an editing system mixes fields from different input frames in only one output frame per second. This one output frame includes the odd or even field from the previous frame and the odd or even field from the subsequent frame. More particularly, twenty-four frames are mapped into fifty fields or frames, which are then played at a rate of fifty fields or frames per second. In this format, there is only one output frame per second in which the fields are from two different input frames. To recreate the original twenty-four frame per second sequence, the frame including the different fields is simply dropped as a whole frame.

### CROSS REFERENCE TO RELATED APPLICATION

This application claims right of priority to and the benefit, under 35 USC § 119(e), of prior filed provisional application Ser. No. 60/789,053, filed on Apr. 4, 2006, which is incorporated herein by reference.

### BACKGROUND

Motion pictures are commonly created using film that captures images at a rate of twenty-four frames per second. It also is possible to create a motion effect by capturing images on film at a different rate, and then play back the film at a rate of twenty-four frames per second.

Major motion pictures that are originally released on film, in a format that is originally intended to be played back at a rate of twenty-four frames per second, are commonly released for television viewing. However, standard television formats have a frame rate that is different from film formats, such as 29.97 frames per second for NTSC television in the United States and twenty-five frames per second for PAL television in Europe and most of Asia. In fact, standard television formats further divide each image into fields of odd lines and fields of even lines such that the field rate is 59.94 fields per second for NTSC and fifty fields per second for PAL. Therefore, a technique called “pulldown” is used to map the images from a twenty-four frame per second format to a 59.94 or fifty field per second format.

For NTSC material, twenty-four progressive frames are mapped into sixty interlaced fields, which are then played at a rate of 59.94 or sixty fields per second. The frames are either recorded and played back at a rate of 23.976 for 59.94 field per second formats, or recorded and played back at a rate of twenty-four frames per second for sixty field per second formats. Given a sequence of four frames A, B, C and D, these frames include odd and even fields A_{O}, A_{E}, B_{O}, B_{E}, C_{O}, C_{E}, D_{O} and D_{E}. These fields are placed into a sequence with some of the fields repeated and some fields reordered, for example: A_{O}A_{E}B_{O}B_{E}B_{O}C_{E}C_{O}D_{E}D_{O}D_{E}. In such a sequence, the frames B_{O}C_{E} and C_{O}D_{E} are mixed and the fields appear out of their original order.

For PAL material, twenty-four frames are mapped into fifty fields, which are then played at a rate of fifty fields per second. Given a sequence of twenty-four frames A1, A2, A3, A4, A5, A6, A7, A8, A9, A10, A11, B1, C1, C2, C3, C4, C5, C6, C7, C8, C9, C10, C11 and D1, the frames include odd and even fields An_{O}, An_{E}, B_{O}, B_{E}, Cn_{O}, Cn_{E}, D_{O} and D_{E}. These fields are placed into a sequence with some of the fields repeated and some fields reordered, for example: A1_{O}A1_{E}, . . . , A11_{O}A11_{E}, B_{O}B_{E}, B_{O}C13_{E}, C13_{O}C14_{E}, Cl4_{O}C15_{E}, . . . , C22_{O}C23_{E}, C23_{O}C23_{E}, D_{O}D_{E}. In such a sequence, all of the frames from the thirteenth through the twenty-third frames are mixed and involve reordering the fields of the Cn frames.

More recently, several formats for digital video cameras also generate motion picture data at a rate of twenty-four or 23.976 frames per second, which is then encoded in a format that corresponds to a typical television frame rate. Commonly, the images generated at twenty-four or 23.976 frames per second are converted into a pulldown format for NTSC and stored as an MPEG-2 or other compressed data stream. For example, the HDV format involves generating high definition video images at a frame rate of twenty-four frames per second. Each image is divided into a field of odd lines and a field of even lines. These images are encoded as a 47.952 field per second sequence using the MPEG-2 compression standard, with the repeat field flag set for those fields which should be repeated upon playback. During playback, a 2-3 pulldown is inserted based upon the repeat field flag.

As another example, for NTSC material, twenty-four frames also may be mapped into sixty fields, which are then played at a rate of 59.94 fields per second using a format referred to by Panasonic as “Advanced Pulldown,” which could be considered 2-3-3-2 pulldown. Given a sequence of four frames A, B, C and D, each frame includes odd and even fields A_{O}, A_{E}, B_{O}, B_{E}, C_{O}, C_{E}, D_{O} and D_{E}. These fields are placed into a sequence with some of the fields repeated and some fields reordered, for example: A_{O}A_{E}B_{O}B_{E}B_{O}C_{E}C_{O}C_{E}D_{O}D_{E}. In such a sequence, only the third frame is mixed (B_{O}C_{E}). In a sequence of thirty fields, there are only six such fields. This format is useful because it is easy to remove what is essentially redundant data from the encoded image data by simply dropping the repeated B_{O} and C_{E} fields as a whole frame. However, this format produces visible motion artifacts when played back as a 29.97 interlaced frame rate video that includes the mixed B_{O}C_{E} frame.

### SUMMARY

A pulldown format for PAL that is useful for material that will be provided to an editing system mixes fields from different input frames in only one output frame per second. This one output frame includes the odd or even field from the previous frame and the odd or even field from the subsequent frame. More particularly, twenty-four frames are mapped into fifty fields or frames, which are then played at a rate of fifty fields or frames per second. Given a sequence of twenty-four frames A1, A2, A3, A4, A5, A6, A7, A8, A9, A0, A11, B1, D1, A12, A13, A14, A15, A16, A17, A18, A19, A20, A21 and A22, each frame includes odd and even fields An_{O}, An_{E}, B_{O}, B_{E}, D_{O}, D_{E}, An_{O} and An_{E}. These fields are placed into a sequence of frames with the B_{O} and D_{E} fields repeated and reordered. For example, the output sequence may be: A1_{O}A1_{E}, . . . , A11_{O}A11_{E}, B_{O}B_{E}, B_{O}D_{E}, D_{O}D_{E}, A12_{O}A12_{E}, . . . , A22_{O}A22_{E}. In this example sequence, only the thirteenth frame is mixed, which is timecode XX:XX:12. In contrast to the PAL pulldown format in which fields of each “C” input frame are present in two different output frames, in this format, there is only one output frame per second in which fields are from two different input frames. To recreate the original twenty-four frame per second sequence, the frame including the repeated B_{O} and D_{E} fields is simply dropped as a whole frame. It should be noted that any specified time code, or any specified frame, can be the frame that includes repeated fields. The invention is not limited to making the thirteenth frame in each second to be the frame that includes the repeated fields.

Such a pulldown format can be created by any video processing device, such as a video camera or film-to-tape transfer system or editing system, that captures or generates progressive images at a twenty-four or 23.976 frame per second rate or corresponding interlaced images at a corresponding field per second rate. By buffering the twelfth input frame, and after capturing the thirteenth input frame, the thirteenth and fourteenth output frames can be constructed and output. In particular, the odd field from the twelfth input frame is output as the odd field of the thirteenth output frame, followed by the even field of the thirteenth input frame. The thirteenth input frame is output as the fourteenth output frame.

The video data in this format can be stored in any of a number of conventional ways, including, but not limited to, an analog or digital PAL video tape, a data file containing the uncompressed image data in the PAL format, or a data file containing compressed image data that originated from uncompressed image data in the PAL format. Example formats for compressed image data include, but are not limited to, MPEG-2 and H.264 compression formats with use data in the compressed data stream to indicate which fields should be repeated.

In an editing system, it may be desirable to edit the video without the pulldown fields inserted. The editing system may remove the pulldown fields or clear any flags in a data stream that indicate that fields are repeated, and use the material in its original frame rate of twenty-four or 23.976 frames per second.

### BRIEF DESCRIPTION OF THE DRAWINGS

FIG. 1 is a diagram illustrating the pulldown format in which one output frame includes the odd or even field from the previous frame and the odd or even field from the subsequent frame.

FIG. 2 is a block diagram of a video processing device that generates a PAL format output from twenty-four or 23.976 frame per second images in the pulldown format of FIG. 1.

FIG. 3 is a flow chart describing a workflow for using PAL format video in the pulldown format of FIG. 1.

### DETAILED DESCRIPTION

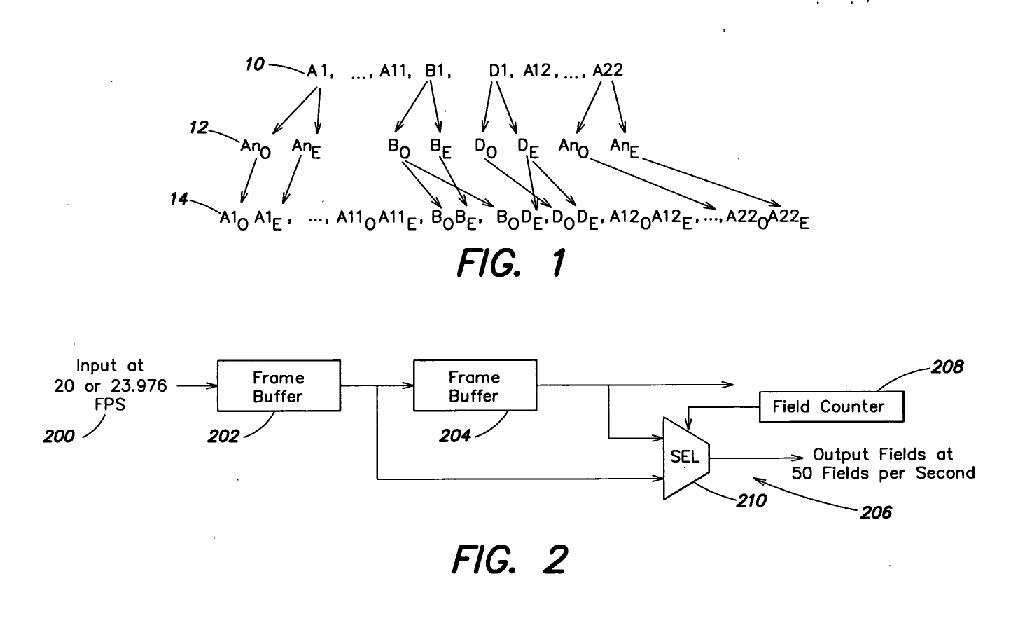

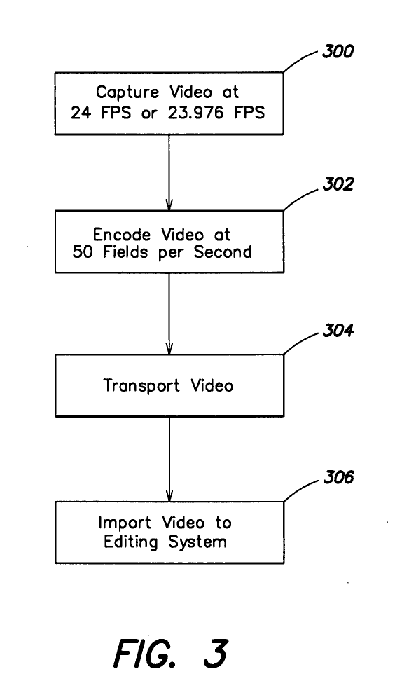

Referring now to FIG. 1, a pulldown format for PAL that is useful for material that will be provided to an editing system mixes fields from different input frames in only one output frame, will now be described. This one output frame includes the odd or even field from the previous frame and the odd or even field from the subsequent frame. More particularly, twenty-four frames are mapped into fifty fields or frames, which are then played at a rate of fifty fields or frames per second. Given a sequence of twenty-four frames A1, A2, A3, A4, A5, A6, A7, A8, A9, A10, A11, B1, D1, A12, A13, A14, A15, A16, A17, A18, A19, A20, A21 and A22, shown at 10 in FIG. 1, each frame includes odd and even fields An_{O}, An_{E}, B_{O}, B_{E}, D_{O}, D_{E}, An_{O} and An_{E}, as shown at 12 in FIG. 1. These fields are placed into a sequence of frames with some of the fields repeated and some fields reordered as shown at 14 in FIG. 1. For example, the output sequence may be: A1_{O}A1_{E} . . . , A11_{O}A11_{E}, B_{O}B_{E}, B_{O}D_{E}, D_{O}D_{E}, A12_{O}A12_{E}, . . . , A22_{O}A22_{E}. In this example sequence, only the thirteenth frame is mixed, which is timecode XX:XX:12. In contrast to standard PAL pulldown format in which fields of each “C” input frame are present in two different output frames, in this format, there is only one output frame per second in which the fields are from two different input frames. To recreate the original twenty-four frame per second sequence, the frame including the repeated B_{O} and D_{E} fields is simply dropped as a whole frame.

Such a pulldown format can be created by any video processing device, such as a video camera or film-to-tape transfer system or editing system, that captures or generates progressive images at a twenty-four or 23.976 frame per second rate or corresponding interlaced images at a corresponding field per second rate. By buffering the twelfth frame, and after capturing the thirteenth frame, the thirteenth and fourteenth output frames can be constructed and output. In particular, the odd field from the twelfth input frame is output as the odd field of the thirteenth output frame, followed by the even field of the thirteenth input frame. The thirteenth input frame is output as the fourteenth output frame.

Referring now to FIG. 2, an example implementation of such pulldown insertion will now be described. The input frames 200 are received at a rate of, for example, twenty-four or 23.976 frames per second, and each frame is initially captured in a first buffer 202. The contents of the first buffer are copied to a second buffer 204 as each subsequent frame is received in the first buffer 202. An output section 206 reads the contents of one field from either the first buffer or second buffer according to the current output time code. For example, a counter 208 may control a selector 210. In particular, for any time code XX:XX:12 (the thirteenth frame of a sequence starting with a timecode XX:XX:00), the output section reads the odd field from the second buffer 204 then the even field from the first buffer 202. It then switches back to the second buffer to read the thirteenth input frame to produce the fourteenth output frame, until the end of the sequence is obtained. The output section reverts back to reading the first buffer 202 upon the next time code XX:XX:00. It should be noted that any specified time code, or any specified frame, can be the frame that includes repeated fields. The invention is not limited to making the thirteenth frame in each second to be the frame that includes the repeated fields.

Instead of generating fifty or 47.952 fields per second of video data from an input video sequence, it is possible to set a flag associated with a field to indicate whether it is repeated, and to store the fields in an order such that during playback the fields are played so as to create the appropriate pulldown. For example, repeat field flags, such as in MPEG-2 and H.264 encoding, may be used; however the encoded bitstream would need to indicate that the even field of the “D” frame should follow the repeated odd field of the previous “B” frame. Such an indication could be provided by ordering the fields in the bitstream so that the even field of the “D” frame both precedes the odd field of the “D” frame and is marked as a repeated field.

The video data in this format can be stored in any of a number of conventional ways, including, but not limited to, an analog or digital PAL video tape, a data file containing the uncompressed image data in the PAL format, or a data file containing compressed image data that originated from uncompressed image data in the PAL format. Example formats for compressed image data include, but are not limited to, MPEG-2 and H.264 compression formats which use data in the compressed data stream to indicate which fields should be repeated.

In an editing system, it may be desirable to edit the video without the pulldown fields inserted. The editing system may remove the pulldown fields or clear any flags in a data stream that indicate that fields are repeated, and use the material in its original frame rate of 24 or 23.976 frames per second. An editing system in which this pulldown format may be used, by either removing repeated fields during capture or by ignoring repeated fields during playback, is described in U.S. Pat. No. 6,618,547, which is hereby incorporated by reference. Where the pulldown is implemented using repeat field flags or other information in the video stream, such as used in the MPEG-2 and H.264 compression formats, an editing system in which this pulldown format may be used is described in U.S. patent application Ser. No. 11/363,718, which is hereby incorporated by reference.

Such an editing system also may use a timecode system that tracks the pulldown phase of each field. For example, in addition to having a time code for each frame, each field within the frame can be assigned an indicator of whether it is an A, B, C or D frame, and an indicator of whether it is an odd or even field. An editing system in which this pulldown phase information may be used is described in U.S. Pat. No. 6,871,003, which is hereby incorporated by reference. This pulldown phase notation can be represented as follows:

TABLE I
PAL PULLDOWN PHASES

| Timecode | Field Phases |
|---|---|
| xx:xx:xx:00 - | A1.1, A1.2 |
| xx:xx:xx:01 - | A2.1, A2.2 |
| xx:xx:xx:02 - | A3.1, A3.2 |
| xx:xx:xx:03 - | A4.1, A4.2 |
| xx:xx:xx:04 - | A5.1, A5.2 |
| xx:xx:xx:05 - | A6.1, A6.2 |
| xx:xx:xx:06 - | A7.1, A7.2 |
| xx:xx:xx:07 - | A8.1, A8.2 |
| xx:xx:xx:08 - | A9.1, A9.2 |
| xx:xx:xx:09 - | A10.1, A10.2 |
| xx:xx:xx:10 - | A11.1, A11.2 |
| xx:xx:xx:11 - | B1.1, B1.2 |
| xx:xx:xx:12 - | B2.3, D1.2 (C) |
| xx:xx:xx:13 - | D2.1, D3.2 |
| xx:xx:xx:14 - | A12.1, A12.2 |
| xx:xx:xx:15 - | A13.1, A13.2 |
| xx:xx:xx:16 - | A14.1, A14.2 |
| xx:xx:xx:17 - | A15.1, A15.2 |
| xx:xx:xx:18 - | A16.1, A16.2 |
| xx:xx:xx:19 - | A17.1, A17.2 |
| xx:xx:xx:20 - | A18.1, A18.2 |
| xx:xx:xx:21 - | A19.1, A19.2 |
| xx:xx:xx:22 - | A20.1, A20.2 |
| xx:xx:xx:23 - | A21.1, A21.2 |
| xx:xx:xx:24 - | A22.1, A22.2 |

A typical workflow using this pulldown technique involves first capturing (300) the motion video. The motion video may be captured in a camera, from an output of a camera into a digital video assist, from a film-to-tape transfer system or any other video system. The captured motion video is then encoded (302) into a fifty field or 47.952 field per second format. The motion video may be captured in a twenty-four or 23.976 frame per second format and later encoded to a fifty or 47.952 field per second format using the pulldown technique described above. Alternatively, the video system may encode the twenty-four or 23.976 frame per second video into a fifty or 47.952 field per second format during capture.

After video data is encoded by either inserting pulldown or by indicating which fields are to be repeated, the encoded video data can be transported (304) to a video processing device such as an editing system. A transport medium may be, for example, a PAL format tape or may be a data file that is stored on a computer readable medium or transmitted over a network.

The transported encoded video then may be imported (306) into a video processing system, such as an editing system. An editing system places segments of the encoded video data into video programs. An editing system typically defines such video programs as one or more sequences (or tracks) of segments (or clips) of video and audio data. The video or audio data typically is stored as computer data files and each clip refers either directly or indirectly to a portion of a data file to define the content of a clip. By removing the repeated pulldown fields, or by ignoring them, or by ignoring or clearing repeat field flags, the editing system can treat the video data as if it is in its original frame rate (of twenty-four or 23.976 frames per second).

After a video program is edited it can be output for playback, exported in an encoded video format for further editing and/or refinement, or can be put into a form for distribution. In most cases, the pulldown format described above is removed from the source material when producing a format for distribution.

The various components of the system described herein may be implemented as a computer program using a general-purpose computer system, or in special-purpose hardware. Special purpose hardware can be used, for example, to introduce the pulldown format during capture, for example in a camera or other field-based capture device.

An implementation as a computer program typically uses a computer system that includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, a cathode ray tube (CRT) display, liquid crystal displays (LCD) and other video output devices, printers, communication devices such as a modem, and storage devices such as disk or tape. One or more input devices may be connected to the computer system. Example input devices include, but are not limited to, a keyboard, keypad, track ball, mouse, pen and tablet, communication device, and data input devices. The invention is not limited to the particular input or output devices used in combination with the computer system or to those described herein.

The computer system may be a general purpose computer system which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services.

A memory system typically includes a computer readable medium. The medium may be volatile or nonvolatile, writeable or nonwriteable, and/or rewriteable or not rewriteable. A memory system stores data typically in binary form. Such data may define an application program to be executed by the microprocessor, or information stored on the disk to be processed by the application program. The invention is not limited to a particular memory system.

A system such as described herein may be implemented in software or hardware or firmware, or a combination of the three. The various elements of the system, either individually or in combination may be implemented as one or more computer program products in which computer program instructions are stored on a computer readable medium for execution by a computer. Various steps of a process may be performed by a computer executing such computer program instructions. The computer system may be a multiprocessor computer system or may include multiple computers connected over a computer network.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method for encoding motion video having a twenty-four frame per second rate into a format having a fifty field per second rate, comprising, for each second of the motion video at twenty-four frames per second:
receiving the motion video, including a first frame, a second frame and twenty-two other frames;
producing output-frames using the twenty-two other frames of motion video;
producing an output frame using the first frame;
producing an output frame using a odd field from the first frame and an even field from the second frame; and
producing an output frame using the second frame.

2. Apparatus for encoding motion video having a twenty-four frame per second rate into a format having a fifty field per second rate, comprising, for each second of the motion video at twenty-four frames per second:
means for receiving the motion video, including a first frame, a second frame and twenty-two other frames;
means for providing output frames using the twenty-two other frames of motion video;
means for providing an output frame using the first frame;
means for providing an output frame using a odd field from the first frame and an even field from the second frame; and
providing an output frame using the second frame.

3. A method for encoding motion video having a 23.976 frame per second rate into a format having a 47.952 per second rate, comprising, for each second of the motion video at twenty-four frames per second:
receiving the motion video, including a first frame, a second frame and twenty-two other frames;
producing output frames using the twenty-two other frames of motion video;
producing an output frame using the first frame;
producing an output frame using a odd field from the first frame and an even field from the second frame; and
producing an output frame using the second frame.

4. Apparatus for encoding motion video having a 23.976 frame per second rate into a format having a 47.952 field per second rate, comprising, for each second of the motion video at twenty-four frames per second:
means for receiving the motion video, including a first frame, a second frame and twenty-two other frames;
means for providing output frames using the twenty-two other frames of motion video;
means for providing an output frame using the first frame;
means for providing an output frame using a odd field from the first frame and an even field from the second frame; and
providing an output frame using the second frame.

5. A method for encoding motion video having a twenty-four frame per second rate into a format having a fifty field per second rate, comprising, for each second of the motion video at twenty-four frames per second:
receiving the motion video, including a first frame, a second frame and twenty-two other frames;
encoding output fields using the twenty-two other frames of motion video;
encoding output fields using the first frame;
identifying an odd field from the first frame and an even field from the second frame as fields to be repeated during playback; and
encoding output fields using the second frame.

6. Apparatus for encoding motion video having a twenty-four frame per second rate into a format having a fifty field per second rate, comprising, for each second of the motion video at twenty-four frames per second:
means for receiving the motion video, including a first frame, a second frame and twenty-two other frames;
means for encoding output fields using the twenty-two other frames of motion video;
means for encoding output fields using the first frame;
means for identifying an odd field from the first frame and an even field from the second frame as fields to be repeated during playback; and
means for encoding output fields using the second frame.

7. A method for encoding motion video having a 23.976 frame per second rate into a format having a 47.952 per second rate, comprising, for each second of the motion video at twenty-four frames per second:
receiving the motion video, including a first frame, a second frame and twenty-two other frames;
encoding output fields using the twenty-two other frames of motion video;
encoding output fields using the first frame;
identifying an odd field from the first frame and an even field from the second frame as fields to be repeated during playback; and
encoding output fields using the second frame.

8. Apparatus for encoding motion video having a 23.976 frame per second rate into a format having a 47.952 field per second rate, comprising, for each second of the motion video at twenty-four frames per second:
means for receiving the motion video, including a first frame, a second frame and twenty-two other frames;
means for encoding output fields using the twenty-two other frames of motion video;
means for encoding output fields using the first frame;
means for identifying an odd field from the first frame and an even field from the second frame as fields to be repeated during playback; and
means for encoding output fields using the second frame.
